(19) United States
(12) Patent Application Publication
(10) Pub. No.: US 2016/0210452 A1
(43) Pub. Date: Jul. 21, 2016

(54) MULTI-GESTURE SECURITY CODE ENTRY

(71) Applicant: Microsoft Technology Licensing, LLC, Redmond, WA (US)

(72) Inventors: Michel Pahud, Kirkland, WA (US); William Buxton, Toronto (CA); Ken Hinckley, Redmond, WA (US); Ahmed Sabbir Arif, Toronto (CA)

(21) Appl. No.: 14/599,966

(22) Filed: Jan. 19, 2015

(51) Int. Cl. G06F 21/32; G06F 3/01; G06F 3/041

(52) U.S. Cl. CPC G06F 21/32; G06F 3/0416; G06F 3/017

(57) ABSTRACT

A processor-implemented method for collecting a sequence of security code characters includes: detecting a trajectory through a region proximate the device followed by an instrument; responsive to the trajectory, identifying one of a collection of defined gestures; and interpreting the identified gesture as the portion of the security code.

### BACKGROUND

The present invention relates to authentication systems and improvements thereto used in connection with controlling access to various processor-enabled devices and for other authentication tasks. Processor-enabled devices may include mobile and non-mobile devices, devices with touch screens and virtual keypads or keyboards, devices with physical keypads or keyboards, devices with projected virtual keypads and keyboards, and numerous other variations.

### SUMMARY

According to aspects of embodiments, a processor-implemented method for defining at least a portion of a security code providing access to a device, includes: detecting a trajectory through a region proximate the device followed by an instrument; responsive to the trajectory, identifying one of a collection of defined gestures; and interpreting the identified gesture as the portion of the security code. The portion of the security code may include the entire code. The region proximate the device may include a surface of the device. According to some variations, the method may further include: detecting a starting point location within one of a collection of defined starting point regions; detecting an indication of an ending point location; and identifying a further portion of the security code based on combining the identified gesture with at least one of the starting point locations. According to further variations, the collection of defined starting point regions includes keys arranged in a keypad. According to yet further variations, the keys include virtual keys on a virtual keypad. The collection of defined starting point regions may include keys arranged in a keyboard. The keys may include virtual keys on a virtual keyboard. According to another variation, identifying may further include: computing a distance and direction between the starting point location and the ending point location; comparing the distance to a threshold above which a gesture is interpreted; and identifying the interpreted gesture as one of up, down, left, and right closest to the computed direction. According to yet another variation, the interpreted gesture further includes diagonals up-left, up-right, down-left, and down-right. Detecting the indication of the ending point location may further include detecting the end point location when the end point location is away from the device. The instrument may be one of a finger, a hand, or a stylus. In some variations, the method may be performed using a portable device wherein the collection of defined gestures includes a collection of reorientations of the portable device. In a further variation, the collection of reorientations of the portable device includes tipping the portable device in one or more of forward, back, left, right, and diagonally.

According to other aspects of embodiments, a system for authenticating a user to a security API of a processor-based device, includes: an input device having a surface; a state machine configured and arranged to detect a gesture made via the input device; and an authentication output communicative with the security API. According to some variations, the state machine is further configured and arranged to detect touches of the surface. According to further variations, the state machine is further configured and arranged to identify touches of the surface as key presses on at least one of a virtual keypad and a physical keypad. According to other variations, the input device further includes: a sensor capable of detecting a trajectory followed by an instrument through a region proximate the surface. According to some further variations, the input device further includes: at least one of an above-screen capacitance sensor, an infrared range-sensor, and a depth camera sensor.

According to yet other aspects of embodiments, a computer-readable medium carrying instructions executable by a processor, the instructions including: detecting a trajectory through a region proximate the device followed by an instrument; responsive to the trajectory, identifying one of a collection of defined gestures; and interpreting the identified gesture as the portion of the security code. The portion of the security code may include the entire code. The region proximate the device may include a surface of the device. According to some variations, the instructions further include: detecting a starting point location within one of a collection of defined starting point regions; detecting an indication of an ending point location; and identifying a further portion of the security code based on combining the identified gesture with at least one of the starting point locations. In other variations, the collection of defined starting point regions includes keys arranged in a keypad, which may include virtual keys on a virtual keypad. In yet another variation, the collection of defined starting point regions includes keys arranged in a keyboard. The keys may include virtual keys on a virtual keyboard. According to another variation, identifying further includes: computing a distance and direction between the starting point location and the ending point location; comparing the distance to a threshold above which a gesture is interpreted; and identifying the interpreted gesture as one of up, down, left, and right closest to the computed direction. According to a yet further variation, the interpreted gesture further includes diagonals up-left, up-right, down-left, and down-right. Detecting the indication of the ending point location may further include: detecting the end point location when the end point location is away from the device. The instrument may be one of a finger, a hand, or a stylus. According to yet a further variation, the method may be performed using a portable device wherein the collection of defined gestures includes a collection of reorientations of the portable device. The collection of reorientations of the portable device includes tipping the portable device in one or more of forward, back, left, right, and diagonally.

In the following description, reference is made to the accompanying drawings, which form a part hereof, and in which are shown example implementations. It should be understood that other implementations are possible, and that these example implementations are intended to be merely illustrative.

### DESCRIPTION OF THE DRAWINGS

FIG. 1 illustrates the geometric relationships between a key and adjacent directions used in a tap and gesture act by a user.

FIG. 2 illustrates the division into regions of a key and adjacent areas so tap and gesture acts can be detected.

FIG. 3 is a block diagram showing how software and hardware embodying aspects of the invention are integrated with conventional components of devices.

FIG. 4 is a flow chart showing how the keypad and keyboard plug-in detect and encode tap and gesture acts.

FIG. 5 is a state diagram illustrating the function of a state machine for detecting gestures such as illustrated in FIG. 2.

FIG. 6 is a state diagram illustrating the function of a state machine for detecting gestures into the third dimension.

FIG. 7 illustrates computing functionality, hardware, and software that can be used to implement any aspect of the features shown in the foregoing drawings.

### DETAILED DESCRIPTION

The following section illustrates aspects of the invention through detailed descriptions of exemplary embodiments and implementations thereof.

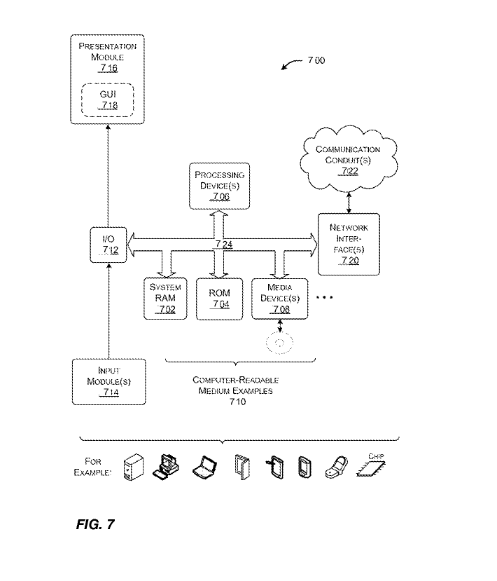

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software, hardware (e.g., chip-implemented logic functionality), firmware, etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 7, to be discussed in turn, provides additional details regarding one illustrative physical implementation of the functions shown in the figures.

Many modern devices especially, but not exclusively, those modern devices based on computers, central processing units, and other similar data processing devices require user authentication prior to performing user-requested tasks. Some of these devices are of more or less general purpose, executing an executive software program known as an operating system in order to provide executive services to other software programs that perform more specific tasks for users. Some of these devices may be application- or task-specific devices that execute an application-specific software program or firmware directly, rather than through the use of the executive services of an operating system. The hardware on which these various types of software programs may execute include mobile devices, such as phones, tablets and the like; portable devices, such as laptop computers, netbooks, and the like; and, substantially fixed devices, such as desktop computers, safes, electronic locking devices, and the like.

One popular conventional authentication technique is a digit lock. Digit lock authentication may be implemented on devices with touch screens by software displaying a virtual, multi-digit keypad or on devices with a physical, multi-digit keypad. A substantial majority of mobile users are known to use this method on mobile devices. To use digit lock authentication, users select a multi-digit personal identification number (PIN), or the authentication system provides the user with a random multi-digit PIN. The user then memorizes the PIN, and later, when the user desires access to the device, the user inputs the PIN using a virtual or physical keypad to unlock their mobile device. Most commonly, the PIN has a length of four digits. Based on a ten-digit keypad and using a four-digit PIN, this authentication method offers 10,000 unique combinations.

A graphical authentication method, called pattern lock, is also conventionally used, for example amongst users of the Android OS. Users of pattern lock select a pattern by connecting a number of dots from a defined grid or other arrangement of dots. Most commonly, four dots are connected in a 3×3, or 3×4 grid.

Connected dots cannot be reused in a single pattern in known implementations of this method. Users are allowed to connect dots with a stroke through other dots, only when those other dots have already been used. Under these conditions, using a 3×3 grid, this method offers 389,112 distinct patterns.

Both of these methods have been criticized for their vulnerability to attacks due to the limited number of possible combinations and the ease with which numerical sequences and dot patterns may be guessed. Pattern locks, for example, may leave oily residue or smudges on a touch screen used to display a virtual pattern lock display, from which it may be possible to guess the password pattern. Numerous alternate methods have been proposed to enhance mobile security, such as image selection that requires users to select sequence of images as passwords, stroke-based textual passwords, where users have to input textual passwords using gestures, multi-word passwords that enforce the selection by users of multiple words as passwords, object-based authentication methods that automatically construct textual passwords from digital objects such as images, etc., biometrics that authenticate users through their fingerprints, typing pattern, face recognition, etc.

Each of the authentication methods mentioned has various drawbacks. The use of complex graphical passwords can enhance mobile security significantly. However, in practice, users often select patterns that are easily predictable. Multi-word methods, in contrast, are usually error-prone and time consuming as it is often challenging to input such passwords using virtual keyboards, at least partly due to small key-sizes and at least partly due to the need for swapping between multiple keyboard layouts to input special characters. Biometrics forces the designer and/or implementer to trade off between two error types, the impostor pass rate and the false alarm rate. Techniques that are substantially different from the dominant digit lock technique also face low adoption rates due to the general unfamiliarity of the user base with such techniques. Poor consumer acceptance may increase the production cost for device manufactures who feel compelled to offer both the traditional method and a novel method substantially different from the traditional method.

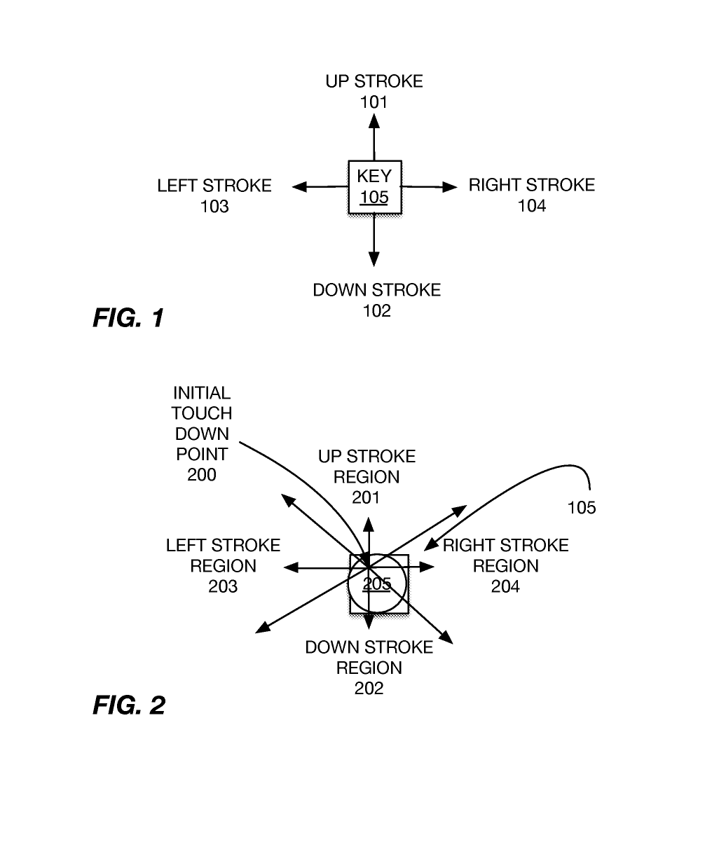

Aspects of an embodiment of a new hybrid user authentication technique, FIG. 1, augments four gestures: up, 101, down, 102, left, 103, and right, 104, to each key, 105, of the ten digit keys from 0 to 9 of a virtual keypad. The four gestures mentioned, the ten digit keys, and the virtual keypad are illustrative examples. Gestures in other directions (e.g. diagonal gestures), more, or fewer gestures are possible, including three-dimensional gestures as explained further below. Instead of digits, a keypad representing abstract symbols, alphabetic characters, alphanumeric combinations, combinations of these, or the like can be used. Instead of a virtual keypad, a virtual keyboard, a physical keypad, a physical keyboard, or the like could serve as the surface or platform against which touches and/or gestures are performed. To initiate these gestures, a user first touches, either physically using their finger or an implement such as a stylus, or virtually using a mouse or other pointer control device, a (virtual or physical) key, 105, and then strokes up, 101, down, 102, left, 103, or right, 104. In other embodiments, described elsewhere herein, proximity of the finger or other implement to a surface of the device is sufficient to begin a gesture, which is then recognized through analysis of the trajectory followed by the finger or other implement in three dimensions. In other embodiments, the permitted strokes may also include other directions, such as the diagonals between up, 101, down, 102, left, 103, or right, 104, or directions in three dimensions, as described elsewhere herein. While selecting a password, one could either tap on a key to select the corresponding digit or initiate any one of the four gestures by touching down on the key, 105, and swiping the finger on the surface of the keypad in one of the four directions to form the stroke, 101, 102, 103, or 104, of the gesture. As the gestures are differentiated based on where they were initiated, a gesture on a specific key is different from the same gesture that was initiated on a different key.

The regions defining each key, 105, and the space around each key can be divided and defined as shown in FIG. 2. The key, 105, has a touch-down region, 205, defined within its boundaries. The touch-down region, 205, may fully occupy the area surrounded by the key, 105, boundary; or, may occupy some smaller region in order to increase the certainty that the touch-down region, 205, clearly indicate the particular key, 105. An up stroke region, 201, down stroke region, 202, left stroke region, 203, and right stroke region, 204, is each defined in a wedge in each of the specified directions. Each region is defined by a wedge radiating from the initial touch down point, 200, wherever that point lies within the touch-down region, 205. Additional or alternate region definitions may be used, for example to include an additional four wedges along diagonal directions, or to provide other layouts or numbers of regions. Optionally, each wedge shown in FIG. 2 for each of the up stroke region, 201, down stroke region, 202, left stroke region, 203, and right stroke region, 204, is separated from adjacent wedges by a guard region (not shown) not considered when determining the direction of a stroke. Any suitable heuristic or deterministic measurement of the combination of touch down in the touch-down region, 205, and swiping through the up stroke region, 201, down stroke region, 202, left stroke region, 203, or right stroke region, 204, may be used to determine the key, 105, and gesture, 101, 102, 103, and 104, performed by a user. The tap and gesture is detected by any suitable touch screen and display combination or physical keypad with a capacitive, resistive, or other touch sensor to determine the touch-down and stroke position and direction.

According to variations, a tap and gesture of the invention could also include movements of the user's finger into the third dimension using any suitable spatial sensor, such as above-screen capacitance sensing capability for touchscreens, infrared range-sensing, depth camera sensing, or other remote-sensing sensor such as those available to detect hovering gestures.

Above-screen capacitive sensing, mentioned above, is currently undergoing development resulting in a new generation of capacitive touch digitizers with extended sensitivity that enable them to sense the geometry of one or more fingers, the hand, or an apparatus such as a stylus, as it approaches the screen. Sensitivity of such technologies has increased the range of detection and measurement up to about 4 cm, but as the technology improves the present invention is not limited to this particular range. Such advanced above-screen and behind the device capacitive sensing technology is expected to come to tablets, phones and other form-factors of mobile and stationary devices. Such an advanced capacitive digitizer enables a device to have both touch and hover detection and measurement within a large three-dimensional space around the surfaces of the device so equipped.

Other technologies that can enable both touch and hover detection and measurement within a large three-dimensional space around the surfaces of the device include IR sensor-emitter pairs embedded in the screen bezel or in the screen pixels themselves, as well as depth camera sensing and ultrasonic detectors tuned for close-distance sensing.

Other keypad alternatives can be used in connection with aspects of the invention. For example, aspects of the invention could be used with a full, virtual keyboard on a tablet device, provided suitable touch and/or remote sensors. The principles are as described in the touch example, but with the gesture defined in three-dimensional space rather than two-dimensional space. The initial point of a gesture could also be defined in three-dimensional space by allowing a specific gesture or tap, even using another finger or hand to indicate the start point, followed by the gesture. In some embodiments, the user may perform a touchdown on a key, as described elsewhere herein, but then instead of sliding the finger on the display, the finger could move up slightly above the display as it goes left, right, up or down instead of sliding directly on the display. Some embodiments could detect as distinct gestures either sliding on the display or movements in a plane spaced a small distance away from the display. In some embodiments, gestures may be defined as trajectories in three dimensions, without requiring a touch on any surface of the device, having an advantage of producing no smudges on the display surface. In such embodiments, trajectories are identified by comparing a detected movement of a finger, hand, or instrument with the permitted or recorded trajectories. The analysis can heuristically align start and end points of a detected gesture candidate with the permitted or recorded gestures, rather than depending on a touch to begin analysis.

Gestures with highly portable devices such as a phone or smartphone can be detected using sensors already incorporated in such devices, as well as new types of sensors, including accelerometers, gyros, GPS, or magnetometers. Unconventional gestures such as how hard the key is struck, or how the device is reoriented for example by tilting after the touch, can be detected by such sensors. In other aspects using such advanced sensors, an unconventional gesture, such as a wave of the phone in a designated direction or pattern prior to gesturing, can be used to designate the start above a defined key or region of the screen of a three-dimensional gesture of the type described above.

As mentioned throughout this description, gestures in two or three dimensions within a three-dimensional region of space containing the screen and device, including within small distances from the boundaries of the screen and device over which suitable detectors can operate define boundaries within which suitable directional alternatives can be defined.

In embodiments using screen-based capacitance sensing technology, the presence of the hand or fingers may be detected both proximal to the display and also beyond its edges. Grip sensing on the back of the device would be another location where extended gestures could be performed. In such an embodiment, a tap on the screen combined with a stroke on the back could also be employed.

Infrared range sensors, or possibly high-frame-rate stripe cameras, along the edges of the device can look outwards and sense presence of a hand, finger, stylus, or other instrumentality out to a certain distance. Hence, long strokes that extend out past the screen edge can also be used, or even strokes that are articulated beyond the bounds of the device.

Cameras are also common on many mobile and other devices. The image captured during authentication can also be combined with the inputs from other sensors to initiate or otherwise qualify gestures. For example, using the camera to capture video or time-lapse images or a mobile depth camera to directly capture hand geometry in close proximity to the screen, the trajectory of the finger to the keyboard or other repeatable characteristics of the user's gesturing can be captured. A device that includes both a camera and a projector that projects a keypad or keyboard on a surface adjacent the device can capture complex trajectories above and to or from the projected keyboard to increase the security of the authentication process.

As mentioned above, the keypad, keyboard, or sensing elements need not be built into a touch screen. Capacitance sensors can be added to physical keyboards. Grip sensing can be done using hover sensor.

Aspects of the invention can be applied to any device locked with a virtual or physical keypad. Wearable keypads can be built into watches and watchbands. The band can include the sensing elements to detect the swipe or gesture.

Separating the surface tapped from the space in which the gesture is made, as some of the foregoing variations permit, further reduces the security issue arising from smudging because any smudges left behind cannot readily be analyzed to identify the gesture performed.

High-resolution sensors can correlate shape of the user's hand with the touch. Various physical characteristics of the touch can be interpolated from the contact, height and force information, and used in connection with the touch to create more complex, but repeatable, gestures. For example, the grip on the device could be used as part of the code. In such embodiments, the user must enter the correct code while gripping the device in a particular way, for example that used when the code was originally created. Other detectable or measurable characteristics associated with a user can also be combined with the gestures described herein, such as biometric information measurable by a high-resolution fingerprint sensor or iris camera, or the like. Advanced, high-resolution sensing surfaces could detect when a particular gesture is performed with a particular finger, for example.

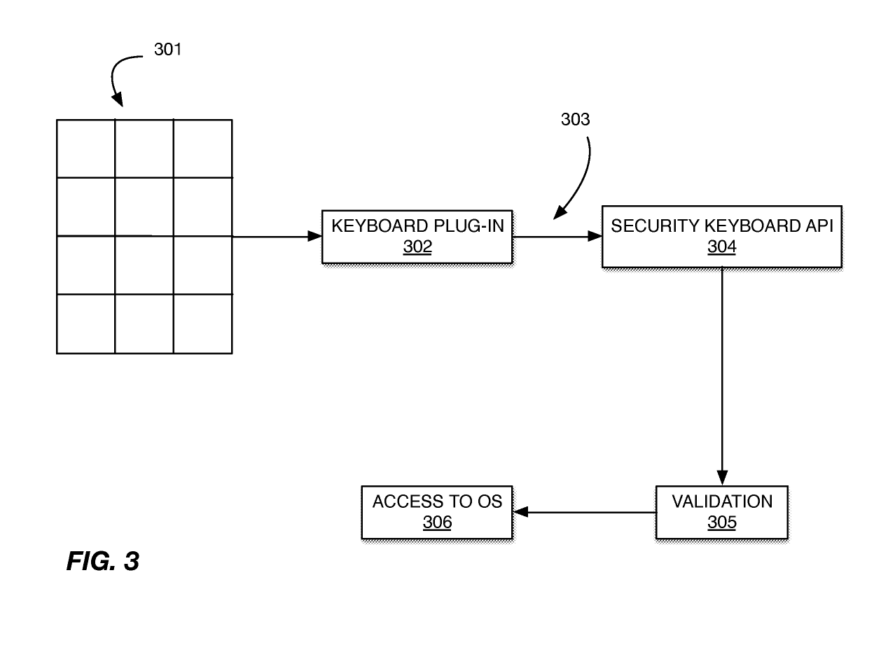

The authentication software implementing aspects of the invention is installed as shown in FIG. 3. A keypad, keyboard, touch screen displaying a virtual keypad, or a similar combination of hardware and software, 301, generates an output in the form of a digital signal or message to a software module, keyboard plug-in, 302. Keyboard plug-in, 302, generates an encrypted authentication signal or message, 303, which is transmitted to a security keyboard application programming interface (API), 304. The API, 304, passes the message to a validation module, 305, which determines whether access to the operating system OS, 306, will be granted.

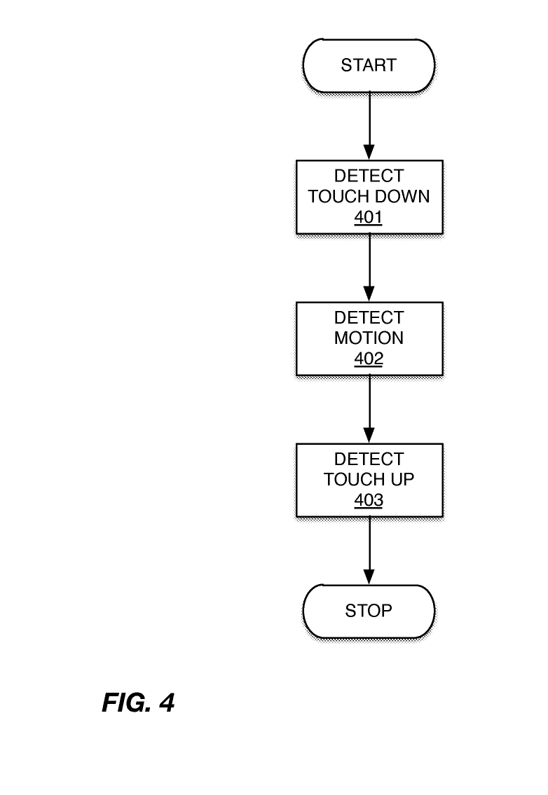

Keyboard plug-in, 302, generates the authentication signal responsive to the tap and gesture performed according to the foregoing description. The authentication signal represents the entire combination of tap and gesture actions taken by a user. In order to determine the authentication signal correctly, the keyboard plug-in, 302, receives from keypad, 301, information determined by a process such as that illustrated in FIG. 4.

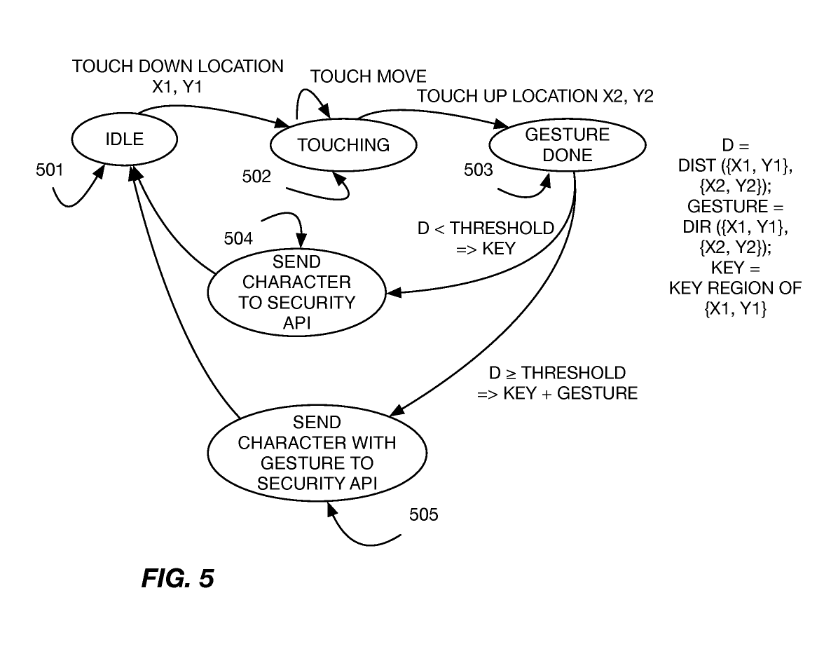

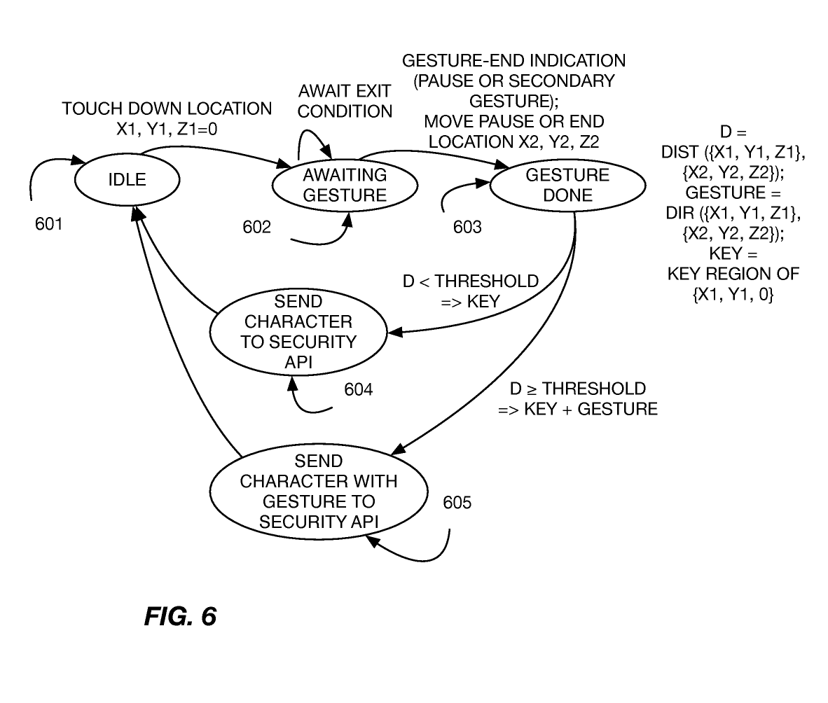

As shown in FIG. 4, the determination of a tap and gesture begins by detecting a touch down, step 401. That is, the location at which the user's finger touches the keypad, 301, is detected, step 401. Next, the motion of the user's finger from the point of touch down is detected, step 402. Thresholds or error functions can be used to determine when movement of the user's finger constitutes “motion” in this context, or when movement of the user's finger is de minimus, and therefore to be disregarded as “motion.” See also, FIGS. 5 and 6. Finally, the lifting of the user's finger (i.e., touch up) from the keypad, 301, is detected, step 403. Detecting touch up, step 403, ends the definition of a tap and gesture sequence. Each tap and gesture sequence is output by the keypad, 301, as a unique signal or message, much as a conventional keypad outputs a signal or message signifying a digit pressed. The method of FIG. 4 is readily adapted to multi-dimensional tap and gesture systems by detecting additional types of motion at step 402, adding steps to detect other acts, or combinations of step 402 (either modified or not) with additional steps to detect other acts. In accordance with other embodiments of the invention, steps 401, 402, and 403 may be combined into an integrated process of continuously observing motion, for example using a sliding window of time or distance moved, and identifying movements over certain segments of time or distance as good matches for previously defined or learned gestures. This alternate process is useful, for example, in detecting as gestures motions in three dimensions that do not start and/or end on a device surface, such as referenced in FIG. 6. Such embodiments rely on additional and/or enhanced sensor types mentioned elsewhere herein, such as enhanced capacitance sensors, depth cameras, infrared sensors along device edges and elsewhere, etc. In the case of enhanced capacitance sensors, the enhancement employs a variation on the standard indium-tin oxide (ITO) or other conductive lines for capacitive touchscreens. There is no separate sensor or digitizer used for the above-screen sensing, the electrical characteristics of the ITO or other conductive lines are selected to produce a more sensitive detector that can discern nearby fingers or other suitable instruments, as well as ones in actual contact with the screen.

The process described in connection with FIG. 4 is now described in further detail with reference to the state diagrams of FIGS. 5 and 6.

In FIG. 5, a non-limiting example of state machine and process for detecting and reporting key and gesture combinations using a two-dimensional surface is described.

Detecting a key touch and/or gesture begins in the Idle state, 501. When a touch is detected at a location X1, Y1, the state moves to the Touching state, 502. The state machine remains in the Touching state, 502, while the user continues to touch and move on the surface. The Touching state, 502, is exited upon detection of a touch up event, and the location X2, Y2 is noted. The touch up information is transmitted into the Gesture Done state, 503, where the distance, gesture, and key are computed based on the touch down location X1, Y1 and the touch up location X2, Y2. If the distance, D, is less than a threshold, then control passes to the Send Character to Security API state, 504; while, if the distance, D, is greater than or equal to the threshold, then control passes to the Send Character and Gesture to Security API state, 505. After sending of the character or the character and gesture to the security API, control returns to the Idle state, 501.

In the case of a three-dimensionally sensitive gesturing system, the state machine may be modified to behave as shown in FIG. 6.

Detecting a key touch and/or gesture begins in the Idle state, 601. When a touch is detected at a location X1, Y1, Z1(=0) or a movement is detected beginning at a location X1, Y1, Z1 the state moves to the Awaiting Gesture state, 602. Optionally, instead of detecting a touch down, ie., Z1=0, a pause or secondary gesture, for example a specific grip, a gesture behind the device, or any other suitable gesture, can be used to indicate the start of a key/gesture combination at any arbitrary point in space. The state machine remains in the Awaiting Gesture state, 602, until the defined exit condition occurs, as given next. The Awaiting Gesture state, 602, is exited upon detection of a gesture-end indication, such as a pause, a gesture in a location behind the device or in some other unconventional region, a secondary gesture made with another input device including for example a user's other finger, or a requirement that each new gesture begin with the use of a different finger, stylus, or input instrumentality, and the location X2, Y2, Z2 is noted (in some cases Z2=0 if the gesture begin in the air and ends by touching the key). Alternatively, the exit of the Awaiting Gesture state, 602, can occur when the movement performed is recognized as a valid gesture. Gestures can be recognized through means at least as varied as computing error functions between measured movements and defined or learned gestures and recognizing various special start and end features such as touch, change of touch location, alternations of touch and gestures in a third dimension, grips, changes in grip, fingerprints of different touching fingers, etc. The gesture-end information is transmitted into the Gesture Done state, 603, where the distance, gesture, and key are computed based on the initial location X1, Y1, Z1 and the final location X2, Y2, Z2. If the distance, D, is less than a threshold, then control passes to the Send Character to Security API state, 604; while, if the distance, D, is greater than or equal to the threshold, or if continuous measurement of the movement determines the gesture to be in three dimensions rather than along the surface, but not a tap, then control passes to the Send Character with Gesture to Security API state, 605. After sending of the character or the character and gesture to the security API, control returns to the Idle state, 601.

In some embodiments, such as described above, the keys and gestures are sent to the security API after each touch up, or after each gesture recognition; in other implementations, the keys and gestures are buffered and the password is sent at once to the security API once the whole sequence is done.

FIG. 7 sets forth illustrative computing functionality 700 that can be used to implement any aspect of the functions described above. For example, the computing functionality 700 can be used to implement any aspect of the invention exemplified in the foregoing description. In one case, the computing functionality 700 may correspond to any type of computing device that includes one or more processing devices. In all cases, the computing functionality 700 represents one or more physical and tangible processing mechanisms. In the context of the invention, the computing functionality 700 may be considered as a whole to be a processor as used herein, or one or more processing devices included in the computing functionality 700 may be considered to be a processor as used herein, as explained below.

The computing functionality 700 can include volatile and non-volatile memory, such as RAM 702 and ROM 704, as well as one or more processing device(s) 706 (e.g., one or more CPUs, and/or one or more GPUs, etc.). The computing functionality 700 also optionally includes various media devices 708, such as a hard disk module, an optical disk module, and so forth. The computing functionality 700 can perform various operations identified above when the processing device(s) 706 executes instructions that are maintained by memory (e.g., RAM 702, ROM 704, and/or elsewhere).

More generally, instructions and other information can be stored on any computer readable medium 710, including, but not limited to, static memory storage devices, and/or magnetic storage devices, and/or optical storage devices, and so on. The term computer readable medium also encompasses plural storage devices. In all cases, the computer readable medium 710 represents some form of physical and tangible entity.

The computing functionality 700 also includes an input/output module 712 for receiving various inputs (via input modules 714), and for providing various outputs (via output modules). One particular output mechanism may include a presentation module 716 and an associated graphical user interface (GUI) 718. The computing functionality 700 can also include one or more network interfaces 720 for exchanging data with other devices via one or more communication conduits 722. One or more communication buses 724 communicatively couple the above-described components together.

The communication conduit(s) 722 can be implemented in any manner, e.g., by a local area network, a wide area network (e.g., the Internet), etc., or any combination thereof. The communication conduit(s) 722 can include any combination of hardwired links, wireless links, routers, gateway functionality, name servers, etc., governed by any protocol or combination of protocols.

Alternatively, or in addition, any of the functions described herein can be performed, at least in part, by one or more hardware logic components. For example, without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In closing, functionality described herein can employ various mechanisms to ensure the privacy of user data maintained by the functionality. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

Further, the description may have described various concepts in the context of illustrative challenges or problems. This manner of explanation does not constitute an admission that others have appreciated and/or articulated the challenges or problems in the manner specified herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A processor-implemented method for defining at least a portion of a security code providing access to a device, comprising:
detecting a trajectory through a region proximate the device followed by an instrument;
responsive to the trajectory, identifying one of a collection of defined gestures; and
interpreting the identified gesture as the portion of the security code.

2. The processor-implemented method of claim 1, further comprising:
detecting a starting point location within one of a collection of defined starting point regions;
detecting an indication of an ending point location; and
identifying a further portion of the security code based on combining the identified gesture with at least one of the starting point locations.

3. The processor-implemented method of claim 2, wherein the collection of defined starting point regions includes keys arranged in a keypad.

4. The processor-implemented method of claim 1, identifying further comprising:
computing a distance and direction between the starting point location and the ending point location;
comparing the distance to a threshold above which a gesture is interpreted; and
identifying the interpreted gesture as one of up, down, left, right, and diagonals up-left, up-right, down-left, and down-right.

5. The processor-implemented method of claim 2, wherein detecting the indication of the ending point location further comprises:
detecting the end point location when the end point location is away from the device.

6. The processor-implemented method of claim 1, wherein the instrument is a one of a finger, a hand, or a stylus.

7. The processor-implemented method of claim 1, performed using a portable device wherein the collection of defined gestures includes a collection of reorientations of the portable device.

8. The processor-implemented method of claim 7, wherein the collection of reorientations of the portable device includes tipping the portable device in one or more of forward, back, left, right, and diagonally.

9. A system for authenticating a user to a security API of a processor-based device, comprising:
an input device having a surface;
a state machine configured and arranged to detect a gesture made via the input device; and
an authentication output communicative with the security API.

10. The system of claim 9, wherein the state machine is further configured and arranged to detect touches of the surface.

11. The system of claim 10, wherein the state machine is further configured and arranged to identify touches of the surface as key presses on at least one of a virtual keypad and a physical keypad.

12. The system of claim 9, the input device further comprising:
a sensor capable of detecting a trajectory followed by an instrument through a region proximate the surface.

13. The system of claim 12, the input device further comprising:
at least one of an above-screen capacitance sensor, an infrared range-sensor, and a depth camera sensor.

14. A computer-readable medium carrying instructions executable by a processor, the instructions comprising:
detecting a trajectory through a region proximate the device followed by an instrument;
responsive to the trajectory, identifying one of a collection of defined gestures; and
interpreting the identified gesture as the portion of the security code.

15. The medium of claim 14, the instructions further comprising:
detecting a starting point location within one of a collection of defined starting point regions;
detecting an indication of an ending point location; and
identifying a further portion of the security code based on combining the identified gesture with at least one of the starting point locations.

16. The medium of claim 15, wherein the collection of defined starting point regions includes keys arranged in a keypad.

17. The medium of claim 14, identifying further comprising:
computing a distance and direction between the starting point location and the ending point location;
comparing the distance to a threshold above which a gesture is interpreted; and
identifying the interpreted gesture as one of up, down, left, right, and diagonals up-left, up-right, down-left, and down-right.

18. The medium of claim 15, wherein detecting the indication of the ending point location further comprises:
detecting the end point location when the end point location is away from the device.

19. The medium of claim 14, wherein the instrument is a one of a finger, a hand, or a stylus.

20. The medium of claim 14, the instructions constructed and arranged to be performed using a portable device wherein
the collection of defined gestures includes a collection of reorientations of the portable device including tipping the portable device in one or more of forward, back, left, right, and diagonally.
